(19) United States
(12) Patent Application Publication
(10) Pub. No.: US 2005/0201035 A1
(43) Pub. Date: Sep. 15, 2005

(54) Connectors having transient voltage suppression components and transient voltage suppression components in a connector

(76) Inventors: Brian J. Buckmeier, San Diego, CA (US); John Matthew Hess, Timonium, MD (US)

Correspondence Address: STEINBERG & RASKIN, P.C., 1140 AVENUE OF THE AMERICAS, 15th FLOOR, NEW YORK, NY, 10036-5803, US

(21) Appl. No.: 10/799,377

(22) Filed: Mar. 12, 2004

(51) Int. Cl. H02H 9/06

(52) U.S. Cl. 361/118

(57) ABSTRACT

A connector is provided including at least one pair of contacts, at least one pair of terminals electrically coupled to the contacts by at least one pair of conductors, and a transient voltage suppression component electrically coupled to the contacts and the terminals. The transient voltage suppression component includes a transient voltage suppression device and a frequency compensation device. The frequency compensation device is coupled in series with the transient voltage suppression device and the transient voltage suppression component is coupling the pair of conductors. The frequency compensation device is an inductor. One of the transient voltage suppression device and one the frequency compensation device are used for each pair of conductors. Alternatively, two of the transient voltage suppression devices and two of the frequency compensation devices are used for each pair of conductors.

### FIELD OF THE INVENTION

The present invention relates generally to electrical connectors and, more particularly, to connectors having transient voltage suppression components, and to transient voltage suppression components for use in connectors.

### BACKGROUND OF THE INVENTION

Certain devices are frequently subject to adverse operation due to transient voltages in electrical lines to which they are connected. For example, communications devices, such as computers, telephones and facsimile machines are adversely affected by transient voltages in communication lines to which they are connected. The transient voltages damage the circuitry of the electronic devices. These electrical devices are not only susceptible to damage from the voltages, but they often transmit the voltages creating erroneous information. The transient voltages may pass through an electrical connector. Therefore, suppression circuitry must be placed between the connected electrical device and the data communication lines to which they are connected to suppress the transient voltages and minimize the transient voltage's effect on the operation of these devices.

Transient voltages come in two types, Electrostatic Discharge (ESD) and Differential voltages. With an ESD, identical or similar voltages flow through the electrical lines connecting these electrical devices. With differential voltages a voltage difference exists between the connecting electrical lines.

The current solution for this problem is to use protection diodes which have a low capacitance value the circuit to keep the transient voltage from passing through the connector. These diodes are expensive due to the fact that they must have a low capacitance value so that they do not effect the frequency of the electrical signals passing through the lines.

### SUMMARY OF THE INVENTION

A connector is provided including at least one pair of contacts, at least one pair of terminals electrically coupled to the contacts by at least one pair of conductors, and a transient voltage suppression component electrically coupled to the contacts and the terminals. The transient voltage suppression component includes a transient voltage suppression device and a frequency compensation device. The frequency compensation device is coupled in series with the transient voltage suppression device and the transient voltage suppression component is coupling the pair of conductors. The frequency compensation device is an inductor. One of the transient voltage suppression device and one the frequency compensation device are used for each pair of conductors. Alternatively, two of the transient voltage suppression devices and two of the frequency compensation devices are used for each pair of conductors.

### BRIEF DESCRIPTION OF THE DRAWINGS

FIG. 1 is a perspective view of a conventional connector;

FIG. 2 is a schematic diagram for the filter circuitry of the conventional connector;

FIG. 3 is a schematic diagram showing TVS components and the filter circuitry of a conventional connector;

FIG. 4 is a schematic diagram showing TVS components and the filter circuitry of a conventional connector;

FIG. 5 is a schematic diagram for the frequency compensation component and transient voltage suppression component for a first embodiment of the present invention;

FIG. 6 is a schematic diagram for the frequency compensation component and transient voltage suppression component for a second embodiment of the present invention;

FIG. 7 is a schematic diagram for the frequency compensation component and transient voltage suppression component for a third embodiment of the present invention;

FIG. 8 is a schematic diagram for the frequency compensation component and transient voltage suppression component for a fourth embodiment of the present invention;

FIG. 9 is a schematic diagram for the frequency compensation component and transient voltage suppression component for a fifth embodiment of the present invention; and

FIG. 10 is a schematic diagram for the frequency compensation component and transient voltage suppression component for a sixth embodiment of the present invention.

### DETAILED DESCRIPTION OF THE PREFERRED EMBODIMENT

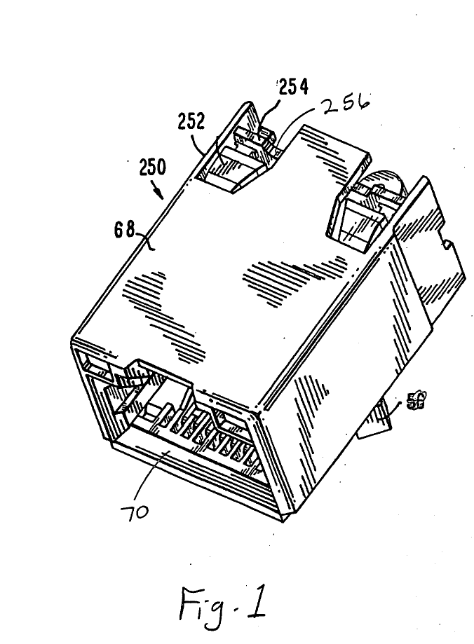

Referring now to FIGS. 1-10 of the drawings, it should be noted that like reference characters designate identical or corresponding parts throughout the several views. A conventional connector assembly is shown and fully described in U.S. Pat. No. 5,736,910.

FIG. 1 shows perspective diagram of a conventional connector assembly 250 including a surface-mountable jack 252 having a housing 68 and defining therein a plug-receiving recess 70. The jack 252 is surface-mounted to a printed circuit board (not shown) in conjunction with a filtering component 254. The filtering component 254 includes a circuit board 256.

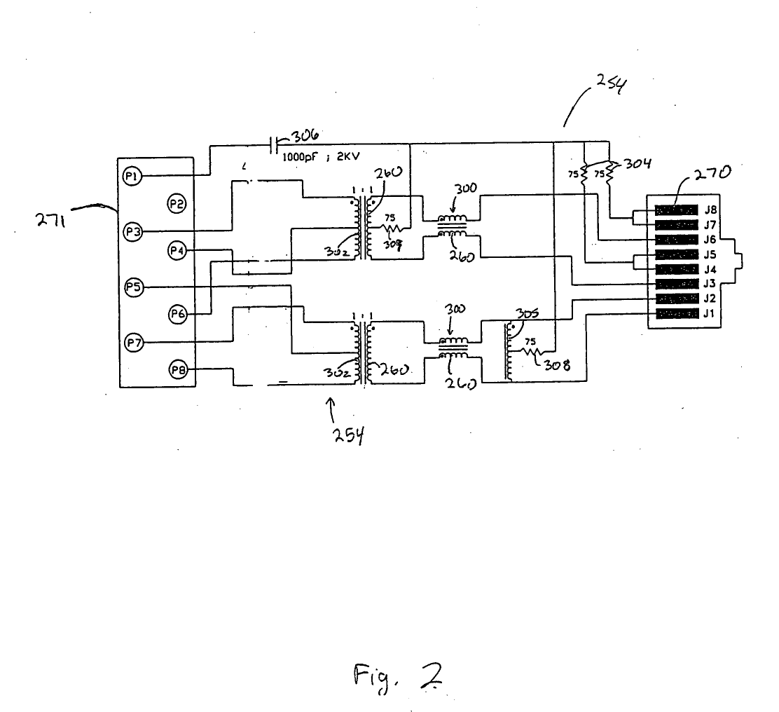

FIG. 2 shows a schematic diagram of a conventional filtering circuit 254 of an electrical connector (not shown). This filter circuit 254 is used for noise suppression and isolation, but does not protect against Electrostatic Discharge (ESD) or Differential Voltages. The torroid 260 is structurally coupled with a magnetic core to form a of common mode choke 300. The autotransformer 305 uses resistors 308 and capacitor 306. Two other torroids 260 form a pair of center tapped transformers 302. One of the center tapped transformers 302 has resistor 309 attached at its midpoint. Additionally, inductor 305 is connected at its midpoint to resistor 308. On the right side of FIG. 2 are indicia J1-J8 corresponding to contacts in the modular connector, and on the left side of FIG. 2 are indicia P1-P8 corresponding to pin contacts from the PC board to the main PC board to which the connector may be mounted.

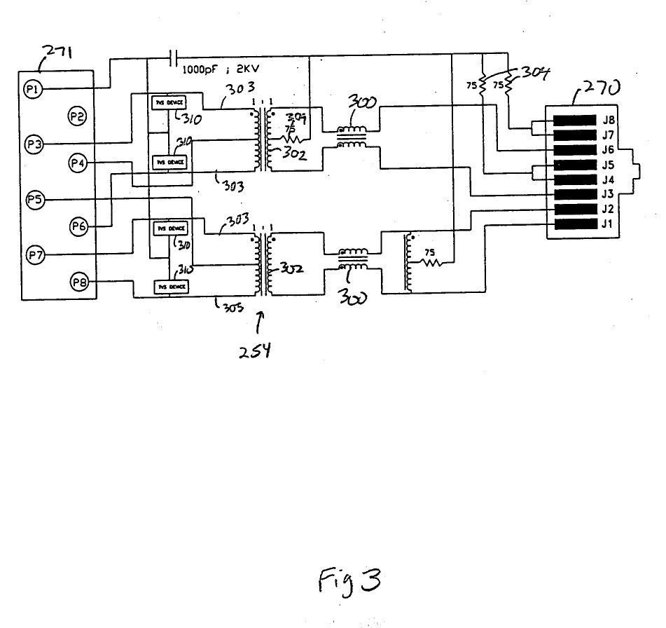

FIG. 3 is a schematic diagram illustrating a conventional circuit using transient voltage suppression components. This circuit protects against ESD and is located on the driver side. The circuit is similar to that shown in FIG. 2. Additionally, four transient voltage suppression (TVS) devices 310 are used. The TVS devices must have a low capacitance so that they do not affect the frequency of the circuit. Therefore, the diodes used, for example are expensive. As shown in FIG. 3, the TVS devices 310 are connected along the lines 303 connected to the center tapped transformers 302 between the center tapped transformers 302 and the PC board pin contacts 271. Two TVS devices 310 electrically coupled together, one TVS device 310 for each one wire of a signal pair, as shown.

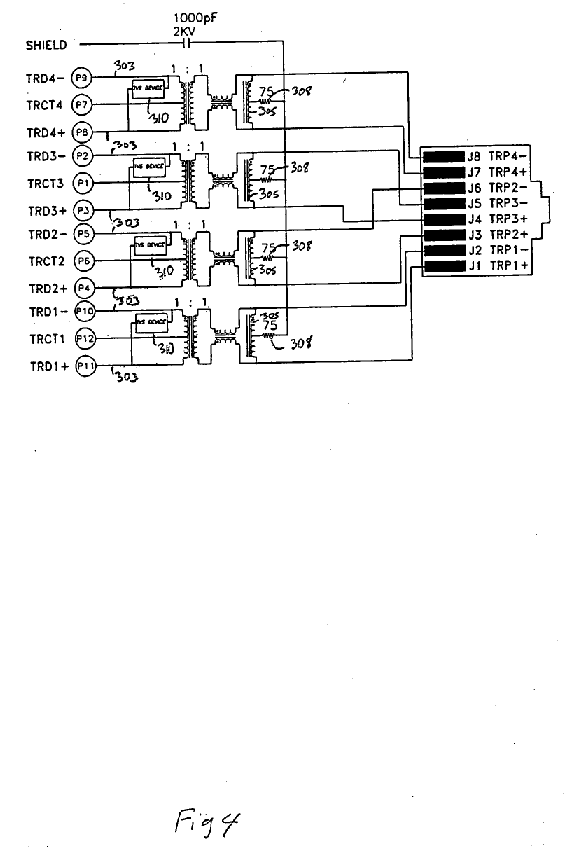

FIG. 4 is a schematic diagram illustrating a second conventional circuit using transient voltage suppression components. This circuit protects against differential voltages and is located on the driver side. The circuit is similar to that shown in FIG. 2. Additionally, there are three additional autotransformers 305 with resistors 308 connected at their midpoint. Four transient voltage suppression (TVS) devices 310 are each along the lines 303 connecting the center tapped transformers 302 to the contacts 271. The TVS devices must have a low capacitance so that they do not affect the frequency of the circuit. Therefore, the diodes used, for example are expensive. Each TVS devices 310 electrically couples together, the two wires of a signal pair.

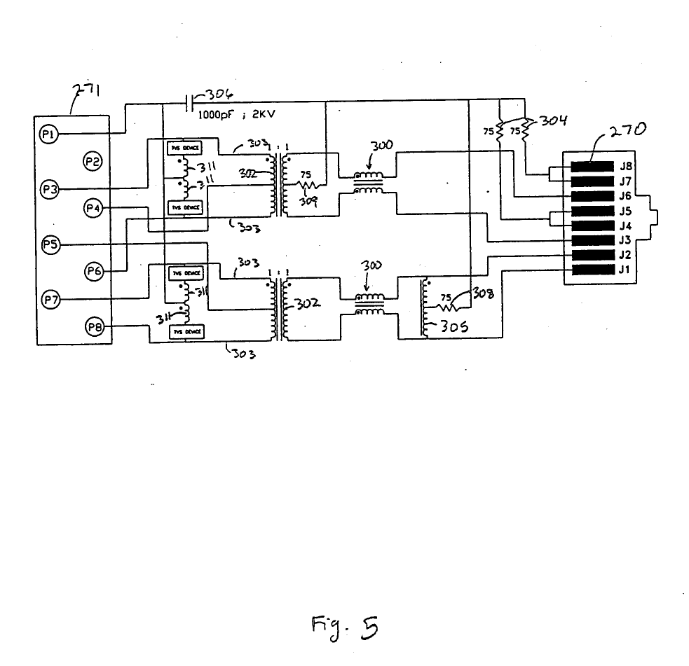

FIG. 5 is a schematic diagram illustrating one embodiment of Applicant's invention. This embodiment protects against ESD and is located on the driver side. The circuit is similar to that shown in FIG. 2. Additionally, four transient voltage suppression (TVS) devices 310 are used. The TVS devices 310 are connected in series with inductors 311 causing the TVS devices 310 to be inductively coupled to the circuit. As shown in FIG. 5, the TVS devices 310 are connected along the lines 303 connected to the center tapped transformers 302 between the center tapped transformers 302 and the PC board pin contacts 271. The TVS devices 310 are inductively coupled together in pairs. Two TVS devices 310 electrically coupled together, one TVS device 310 for each one wire of a signal pair.

In operation, the inductor 311 magnetically saturates itself when a transient event occurs. In a saturated state, the inductor 311 acts as a short circuit, thus becoming transparent to the transient signal in the circuit allowing for the suppression of the transient signal.

Use of the inductors 311 causes the TVS devices 310 to be frequency compensated. Therefore, the TVS devices used do not have to have low capacitances. The inductor 311 is used to neutralize the shunt or parallel capacitance of the TVS device 310. This allows the TVS device 310 to be transparent to the data signal. If the TVS device 310 was not frequency compensated with an inductor 311, the TVS 310 would change characteristics of the circuit affecting the time and frequency domain response of a signal during normal operation.

Since TVS devices are inductively coupled and therefore frequency compensated, the capacitance of the TVS device does not have to be kept low. Therefore, the TVS device is transparent to the circuit and does not affect the frequency. This allows the diodes used, for example to be less expensive. For example, when the TVS is not inductively coupled, 2 low capacitance diodes manufactured by Supplier A and purchased at a cost of $2.00 may be used. When the TVS is inductively coupled, 4 higher capacitance diodes manufactured by Supplier B and purchased at a cost of $0.08 may be used. Therefore, a savings of $1.92 per TVS is realized.

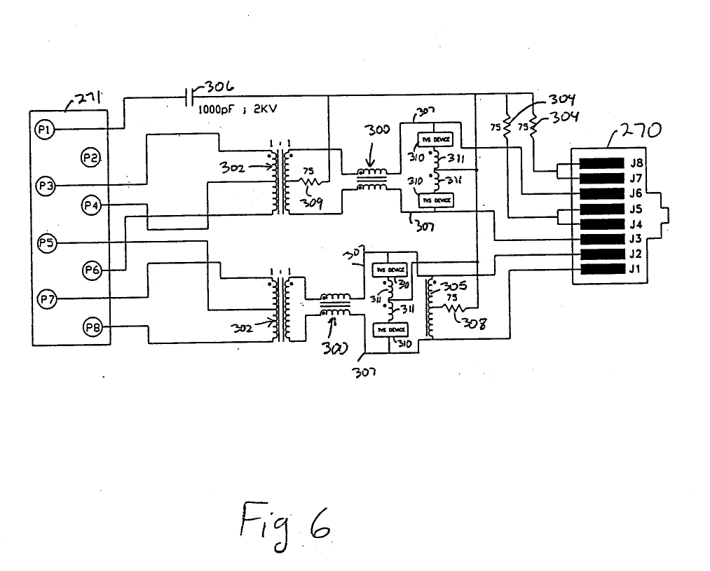

FIG. 6 is a schematic diagram illustrating a second embodiment of Applicant's invention. This embodiment protects against ESD and is located on the line side. The circuit is similar to that shown in FIG. 2. The four transient voltage suppression (TVS) devices 310 are connected in series with inductors 311 causing the TVS devices 310 to be inductively coupled to the circuit. As shown in FIG. 6, the TVS devices 310 are connected along the lines 307 connecting the common mode chokes 300 and the contacts 270. The TVS devices 310 are inductively coupled together in pairs.

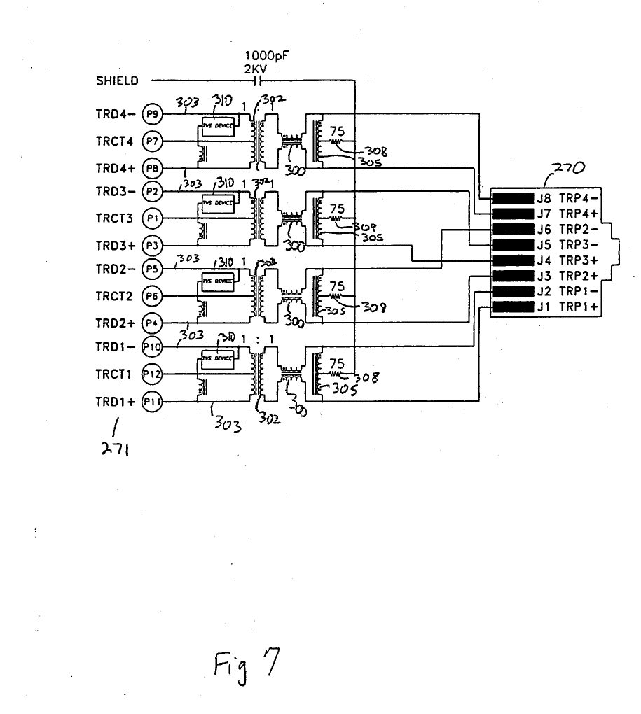

FIG. 7 is a schematic diagram illustrating a third embodiment of Applicant's invention. This embodiment protects against differential voltages and is located on the driver side. The circuit is similar to that shown in FIG. 2. Additionally, there are three additional inductors 305 with resistors 308 connected at their midpoint. None of the center tapped transformers have a resistor attached at its midpoint. The four transient voltage suppression (TVS) devices 310 are each connected in series with one inductor 311 causing the TVS devices 310 to be inductively coupled to the circuit. As shown in FIG. 7, the TVS devices 310 are connected along the lines 303 connecting the center tapped transformers 302 to the contacts 271.

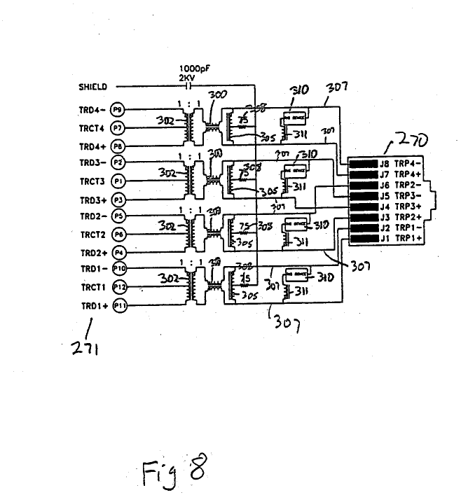

FIG. 8 is a schematic diagram illustrating a fourth embodiment of Applicant's invention. This embodiment protects against differential voltages and is located on the line side. The circuit is similar to that shown in FIG. 2. The four transient voltage suppression (TVS) devices 310 are each connected in series with one inductor 311 causing the TVS devices 310 to be inductively coupled to the circuit. As shown in FIG. 8, the TVS devices 310 are connected along the lines 307 connecting the common mode chokes 300 and the contacts 270.

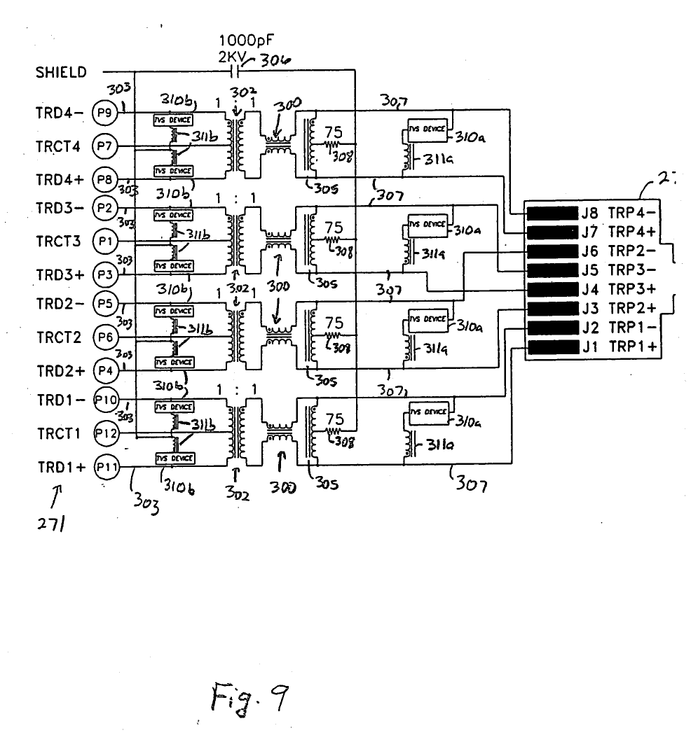

FIG. 9 is a schematic diagram illustrating a fifth embodiment of Applicant's invention. This embodiment protects against both ESD and differential voltages. The circuit is similar to that shown in FIGS. 6 and 7 combined. Eight transient voltage suppression (TVS) devices 310a are each connected in series with one inductor 311a causing the TVS devices 310a to be inductively coupled to the circuit. As shown in FIG. 9, the TVS devices 310a are connected along the lines 307 connecting the common mode chokes 300 and the contacts 270. Four transient voltage suppression (TVS) devices 310b are each connected in series with one inductor 311b causing the TVS devices 310b to be inductively coupled to the circuit. As shown in FIG. 9, the TVS devices 310b are connected along the lines 303 connecting the center tapped autotransformers 302 to the contacts 271. This shows that ESD and differential protection can be combined.

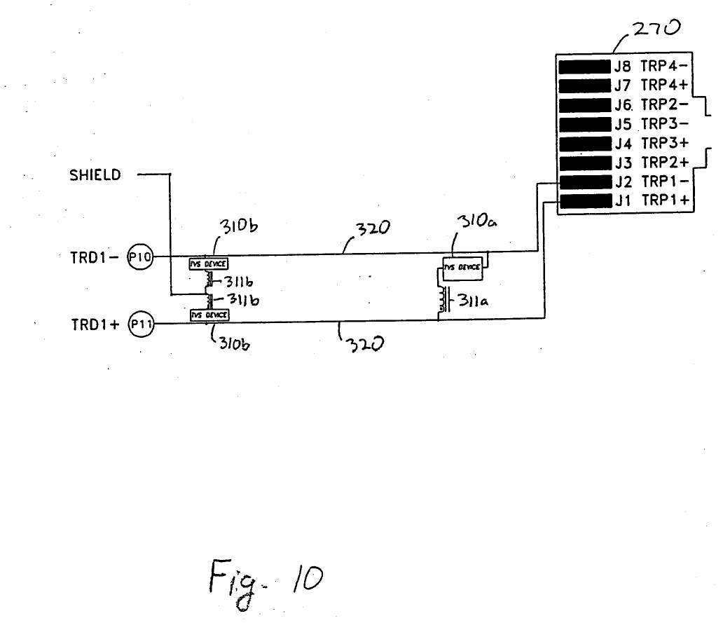

FIG. 10 is a schematic diagram illustrating a sixth embodiment of Applicant's invention. This embodiment protects against both ESD and differential voltages and does not include the filtering elements. This circuit contains only one signal pair 320. The circuit is similar to a portion of the circuit shown in FIG. 2. One transient voltage suppression (TVS) device 310a is connected in series with one inductor 311a causing the TVS device 310a to be inductively coupled to the circuit. Two transient voltage suppression (TVS) devices 310b are each connected in series with two inductors 311b causing the TVS devices 310b to be inductively coupled to the circuit. All the TVS devices 310 are connected along the signal pair 320. The ends of the inductors 311b not connected to the TVS devices 311b are connected together at ground.

Although the invention has been described with respect to preferred embodiment, it is understood that changes and modifications can be made which are within the full intended scope of the invention as defined by the appended claims.

1. A connector comprising:
at least one pair of contacts;
at least one pair of terminals electrically coupled to said contacts by at least one pair of conductors; and
a transient voltage suppression component electrically coupled to said contacts and said terminals including:
a transient voltage suppression device and a frequency compensation device.

2. The connector of claim 1 wherein said frequency compensation device is coupled in series with said transient voltage suppression device.

3. The connector of claim 2 wherein said transient voltage suppression component is coupling said pair of conductors.

4. The connector of claim 2 wherein said frequency compensation device is an inductor.

5. The connector of claim 2 wherein one of said transient voltage suppression device and one said frequency compensation device are used for each pair of conductors.

6. The connector of claim 2 wherein two of said transient voltage suppression devices and two of said frequency compensation devices are used for each pair of conductors.

7. The connector of claim 5 wherein each of said transient voltage suppression devices is coupled to each of the first of said conductors, and each of said frequency compensation devices is coupled to each of the second of said conductors.

8. The connector of claim 6 wherein the first of said transient voltage suppression devices is coupled to each of the first of said conductors, and each of the second of said transient voltage suppression devices is coupled to each of the second of said conductors, and said frequency compensation devices are coupled to ground.

9. The connector of claim 2 wherein a first set of said transient voltage suppression device and a first set of said frequency compensation device are used for each pair of conductors and wherein two of a second set of said transient voltage suppression devices and two of a second set of said frequency compensation devices are also used for each pair of conductors.

10. The connector of claim 9 wherein each of a first set of said transient voltage suppression devices is coupled to each of the first of said conductors, and each of a first set of said frequency compensation devices is coupled to each of the second of said conductors and wherein the first of a second set of said transient voltage suppression devices is coupled to each of the first of said conductors, and each of the second of a second set of said transient voltage suppression devices is coupled to each of the second of said conductors, and said second set of frequency compensation devices are coupled to ground.

11. The connector according to claim 1 and further comprising a filter component electrically coupled to said pair of conductors.

12. The connector of claim 1 wherein said transient voltage suppression device includes a varistor.

13. The connector of claim 1 wherein said transient voltage suppression device includes a zener diode.

14. The connector of claim 1 wherein said transient voltage suppression device includes a diode.

15. The connector according to claim 1 wherein said transient voltage suppression component includes a current limiting device.

16. The connector of claim 1 wherein said transient voltage suppression device includes a voltage limiting device.

17. The connector of claim 1 wherein said transient voltage suppression device protects against electrostatic discharge.

18. The connector of claim 1 wherein said transient voltage suppression device protects against differential voltage surges.

19. The connector of claim 1 wherein said transient voltage suppression device protects against voltage surges above a certain threshold.

20. The connector of claim 4 wherein said inductor magnetically saturates itself when it encounters a transient voltage.

21. A transient voltage suppression component for use in a connector, said connector having at least one pair of contacts and at least one pair of terminals electrically coupled to said contacts by at least one pair of conductors and said transient voltage suppression component electrically coupled to said contacts and said terminals, said transient voltage suppression component comprising:
a transient voltage suppression device and a frequency compensation device.

22. The transient voltage suppression component of claim 21 wherein said frequency compensation device is coupled in series with said transient voltage suppression device.

23. The transient voltage suppression component of claim 22 wherein said transient voltage suppression component is coupling said pair of conductors.

24. The transient voltage suppression component of claim 22 wherein said frequency compensation device is an inductor.

25. The transient voltage suppression component of claim 22 wherein one of said transient voltage suppression device and one said frequency compensation device are used for each pair of conductors.

26. The transient voltage suppression component of claim 22 wherein two of said transient voltage suppression devices and two of said frequency compensation devices are used for each pair of conductors.

27. The transient voltage suppression component of claim 25 wherein each of said transient voltage suppression devices is coupled to each of the first of said conductors, and each of said frequency compensation devices is coupled to each of the second of said conductors.

28. The transient voltage suppression component of claim 26 wherein the first of said transient voltage suppression devices is coupled to each of the first of said conductors, and each of the second of said transient voltage suppression devices is coupled to each of the second of said conductors, and said frequency compensation devices are coupled to ground.

29. The transient voltage suppression component of claim 22 wherein a first set of said transient voltage suppression device and a first set of said frequency compensation device are used for each pair of conductors and wherein two of a second set of said transient voltage suppression devices and two of a second set of said frequency compensation devices are also used for each pair of conductors.

30. The transient voltage suppression component of claim 29 wherein each of a first set of said transient voltage suppression devices is coupled to each of the first of said conductors, and each of a first set of said frequency compensation devices is coupled to each of the second of said conductors and wherein the first of a second set of said transient voltage suppression devices is coupled to each of the first of said conductors, and each of the second of a second set of said transient voltage suppression devices is coupled to each of the second of said conductors, and said second set of frequency compensation devices are coupled to ground.

31. The transient voltage suppression component according to claim 21 and further comprising a filter component electrically coupled to said pair of conductors.

32. The transient voltage suppression component of claim 21 wherein said transient voltage suppression device includes a varistor.

33. The transient voltage suppression component of claim 21 wherein said transient voltage suppression device includes a zener diode.

34. The transient voltage suppression component of claim 21 wherein said transient voltage suppression device includes a diode.

35. The transient voltage suppression component according to claim 21 wherein said transient voltage suppression component includes a current limiting device.

36. The transient voltage suppression component of claim 21 wherein said transient voltage suppression device includes a voltage limiting device.

37. The transient voltage suppression component of claim 21 wherein said transient voltage suppression device protects against electrostatic discharge.

38. The transient voltage suppression component of claim 21 wherein said transient voltage suppression device protects against differential voltage surges.

39. The transient voltage suppression component of claim 21 wherein said transient voltage suppression device protects against voltage surges above a certain threshold.

40. The transient voltage suppression component of claim 24 wherein said inductor magnetically saturates itself when it encounters a transient voltage.

41. A circuit, comprising:
a conductor;
a transient voltage suppression component electrically coupled to said conductor said transient voltage suppression component including:
a transient voltage suppression device and a frequency compensation device.

42. The circuit according to claim 1 wherein said transient voltage suppression component is inductively coupled to said conductor.

43. A method of protecting a circuit comprising:
introducing a signal having a frequency to the circuit;
shunting a transient voltage introduced to the circuit using a transient voltage suppression device; and
frequency compensating for the shift in frequency caused by the capacitance of the transient voltage suppression device.

44. The method of claim 43 and further comprising the step of inductively coupling the transient voltage suppression device with a frequency compensation device.
